(19) United States
(12) Patent Application Publication
(10) Pub. No.: US 2026/0254210 A1
(43) Pub. Date: Aug. 27, 2026

(54) CLOSED FIXTURE DEVICE FOR REPLACING SINGLE INSULATOR AND REPLACEMENT METHOD THEREOF

(71) Applicant: Anpower Link Electric Automatization Co., Ltd., Anshan (CN)

(72) Inventors: Yaoyang HUANG, Anshan (CN); Dewei ZHANG, Anshan (CN)

(21) Appl. No.: 19/651,883

(22) Filed: Apr. 20, 2026

(30) Foreign Application Priority Data
Mar. 25, 2026 (CN) 202610368696.6

(51) Int. Cl. H02G 1/02

(52) U.S. Cl. CPC H02G 1/02

(57) ABSTRACT

A closed fixture device for replacing a single insulator and a replacement method thereof are provided, the device includes a first fixture, a second fixture, tightening assemblies and extension joints, where the first fixture and the second fixture are respectively clamped and positioned on an insulator string; a retractable bearing structure is formed by connecting two the extension joints and the tightening assemblies between the first fixture and the second fixture; and the first fixture and/or the second fixture include a main clamp and an auxiliary clamp cover and are connected by pin shafts, special-shaped articulated bolts and nuts; a center of the main clamp is a semi-circular arc body, with symmetrically arranged ear plates on both sides; the ear plates are provided with connecting holes for connecting the extension joints or the tightening assemblies; the special-shaped articulated bolts are symmetrically assembled on the main clamp.

### CROSS-REFERENCE TO RELATED APPLICATIONS

This application claims priority of Chinese Patent Application No. 2026103686966, filed on March 25, 2026, the content of which is hereby incorporated by reference.

### TECHNICAL FIELD

The disclosure relates to the technical field of insulator overhaul and maintenance , and in particular to a closed fixture device for replacing a single insulator and a replacement method thereof.

### BACKGROUND

In overhead transmission lines, insulator strings are key components that support conductors and ensure electrical insulation between conductors and transmission towers. Insulators are widely used due to the high strength and stable performance. Such insulators consist of tempered glass (ceramic) insulators/disks, steel caps and steel pins. Multiple units are connected in series by ball-and-socket joints between steel caps and steel pins to form an insulator string, which is suspended between conductors and transmission towers. During long-term operation, insulators may suffer from self-explosion or damage caused by lightning strikes, aging or manufacturing defects, resulting in low-value or zero-value insulators, which seriously threaten the safety of transmission lines. In such cases, faulty insulators may be replaced in a timely manner.

However, traditional replacement operations face the following technical bottlenecks and potential safety hazards: firstly, inefficient and restricted operation methods: the conventional practice is to replace the entire insulator string, which involves large-scale operation, high labor intensity and many operators; secondly, insufficient adaptability of existing fixtures: the existing fixtures may not replace insulators at any position and usually require replacement of the whole string, which brings potential safety risks; thirdly, the existing operation technology involves complicated assembly and disassembly processes, which further increase operation difficulty and safety risks under severe high-altitude environments and seriously affect replacement efficiency.

Therefore, there is an urgent need for an insulator replacement fixture device that is easy to assemble and disassemble, may replace insulators at any position, and may ensure operation safety.

### SUMMARY

The purpose of the disclosure is to provide a closed fixture device for replacing a single insulator and a replacement method thereof, so as to solve the above problems in the prior art.

In order to solve the technical problems, the disclosure adopts the following technical scheme.

A closed fixture device for replacing a single insulator is provided, and includes: a first fixture, a second fixture, tightening assemblies and extension joints, where the first fixture and the second fixture are respectively clamped and positioned on an insulator string; a retractable bearing structure is formed by connecting two the extension joints and the tightening assemblies between the first fixture and the second fixture; and the first fixture and/or the second fixture include a main clamp and an auxiliary clamp cover and are connected by pin shafts, special-shaped articulated bolts and nuts; a center of the main clamp is a semi-circular arc body, with symmetrically arranged ear plates on both sides; the ear plates are provided with connecting holes for connecting the extension joints or the tightening assemblies; the special-shaped articulated bolts are symmetrically assembled on the main clamp; the main clamp and the auxiliary clamp cover are connected in combination through the special-shaped articulated bolts, the pin shafts and the nuts, and and a central hole is formed for accommodating an insulator steel cap after combination; and a stress surface of the central hole is matched with a fitting section of a steel cap boss.

Further, the second fixture is a crossarm end fixture for a tension string, the crossarm end fixture is clamped at a connecting position between a connecting plate and a socket-clevis eye; a middle internal cavity of the first fixture is clamped on a stress fitting surface of the insulator steel cap, so as to replace a first insulator on a tension string crossarm side; the crossarm end fixture, the first fixture and the tightening assemblies form a retractable device.

Further, the first fixture is a conductor end fixture for a tension string, the conductor end fixture is clamped on a pulling plate, one end of the insulator string is provided with the pulling plate, and the conductor end fixture is clamped to the pulling plate; a middle internal cavity of the second fixture is clamped on a stress fitting surface of the insulator steel cap, so as to replace a first insulator on a tension string conductor side; the conductor end fixture, the second fixture and the tightening assemblies form a retractable device.

Further, the second fixture is a conductor end fixture for a straight line string, a middle shaped groove of the conductor end fixture is clamped on a balance connecting plate, a middle internal cavity of the first fixture is clamped on a stress fitting surface of the insulator steel cap, so as to replace a first insulator on a straight line string conductor side, and the conductor end fixture, the first fixture and the tightening assemblies form a retractable device.

Further, the first fixture is a crossarm end fixture for a straight line string, one end of the insulator string is provided with a U-shaped hanger plate and a ball eye, a middle shaped groove of the crossarm end fixture is clamped on the U-shaped hanger plate and the ball eye, a middle internal cavity of the second fixture is clamped on a stress fitting surface of the insulator steel cap, so as to replace a first insulator on a straight line string crossarm side, and the crossarm end fixture, the second fixture and the tightening assemblies form a retractable device.

Further, the first fixture and the second fixture have a same structure, and both the first fixture and the second fixture are fittingly clamped and positioned in cooperation with a stress surface of the insulator steel cap, and the first fixture, the second fixture and the tightening assemblies form a retractable device.

Further, the first fixture and/or the second fixture include the main clamp and the auxiliary clamp cover, and are connected by the pin shafts, the special-shaped articulated bolts and the nuts, and an openable and closable semi-circular arc body is formed, and an internal cavity is completely fitted with a stress fitting surface of the insulator steel cap.

Further, each of the tightening assemblies is a labor-saving gear tightening screw, a mechanical ratchet tightening screw or a manual hydraulic tensioner.

A method for replacing a single insulator is further provided, the method adopts the closed fixture device for replacing a single insulator, and includes:

S1: determining a position of an insulator to be replaced in the insulator string;

S2: selecting installation positions and types of the first fixture and the second fixture according to the position of the insulator to be replaced:

if replacing a first insulator on a tension string crossarm side, using the second fixture as a crossarm end fixture of a tension string and clamping at a connecting position between a connecting plate and a socket-clevis eye, determining an installation position of the first fixture on the insulator string and installing the first fixture;

if replacing a first insulator on a tension string conductor side, using the first fixture as a conductor end fixture of a tension string and clamping on a pulling plate, determining an installation position of the second fixture on the insulator string and installing the second fixture;

if replacing a first insulator on a straight line string conductor side, using the second fixture as a conductor end fixture of a straight line string and clamping on a balance connecting plate, and clamping a middle internal cavity of the first fixture on a stress fitting surface of the insulator steel cap;

if replacing a first insulator on a straight line string crossarm side, using the first fixture as a crossarm end fixture of a straight line string and clamping on a U-shaped hanger plate and a ball eye, and clamping a middle internal cavity of the second fixture on a stress fitting surface of the insulator steel cap;

if replacing an insulator at any position in the insulator string, respectively clamping the first fixture and the second fixture on the insulator steel cap, and installing and fastening;

S3: selecting whether to use the extension joints and adjusting installation lengths of the tightening assemblies according to a distance between the first fixture and the second fixture;

S4: connecting and fastening both ends of each of the tightening assemblies with the first fixture and the second fixture respectively;

S5: operating the tightening assemblies to gradually bear force until the insulator to be replaced is loosened; and

S6: disassembling the insulator to be replaced and installing a new insulator.

Further, each of the tightening assemblies is a labor-saving gear tightening screw, a mechanical ratchet tightening screw or a manual hydraulic tensioner, and in S5, a corresponding tool is used to operate the tightening assemblies to gradually tighten.

Further, during installation of the first fixture and/or the second fixture, the main clamp and the auxiliary clamp cover are combined through the special-shaped articulated bolts, the pin shafts and the nuts to form the central hole fitted with a stress surface of the insulator steel cap.

Further, in S5, each of the tightening assemblies is operated until mechanical load of the insulator to be replaced in the insulator string is completely unloaded.

Compared with the prior art, the disclosure has the following beneficial technical effects.

First, the fixture device for replacing a single insulator of the disclosure adopts a modular structure, realizing rapid positioning and replacement of insulators at the crossarm side, conductor side and any intermediate position of the insulator string, solving the problem that the conventional operation requires replacement of the entire string or that a special fixture may only be used for a single position, and significantly improving the versatility and operation flexibility of the tool.

Second, the fixture device for replacing a single insulator of the disclosure is provided with the first fixture and the second fixture, where the first fixture and/or the second fixture include the main clamp and the auxiliary clamp cover connected by pin shafts, special-shaped articulated bolts and nuts, forming an openable and closable semi-circular arc body. The internal cavity thereof is completely fitted with the stress fitting surface of the insulator steel cap, so that the insulator steel cap may be firmly clamped, thereby realizing safe replacement of an insulator at any intermediate position of a tension string or a straight line string.

Third, the fixture device for replacing a single insulator of the disclosure forms a retractable device by the crossarm end fixture for a tension string, the first fixture and the tightening assembly. The crossarm end fixture is clamped at the connecting pisition between the connecting plate and the socket-clevis eye, and the middle internal cavity of the first fixture is clamped on the stress fitting surface of the insulator steel cap without interfering with the front and rear insulators. By means of the tightening assemblies, the first insulator on the tension string crossarm side may be replaced.

Fourth, the fixture device for replacing a single insulator of the disclosure forms a retractable device by the conductor end fixture for a tension string, the second fixture and the tightening assemblies. The conductor end fixture is clamped on the pulling plate, and the middle internal cavity of the second fixture is clamped on the stress fitting surface of the insulator steel cap without interfering with the front and rear insulators. By means of the tightening assemblies, the first insulator on the tension string conductor side may be replaced.

Fifth, the fixture device for replacing a single insulator of the disclosure forms a retractable device by the conductor end fixture for a straight line string, the first fixture and the tightening assemblies. The middle shaped groove of the conductor end fixture is clamped on the balance connecting plate, and the middle internal cavity of the first fixture is clamped on the stress fitting surface of the insulator steel cap without interfering with the front and rear insulators. By means of the tightening assemblies, the first insulator on the straight line string conductor side may be replaced.

Sixth, the fixture device for replacing a single insulator of the disclosure forms a retractable device by the crossarm end fixture for a straight line string, the second fixture and the tightening assemblies. One end of the insulator string is provided with a U-shaped hanger plate and a ball eye. The middle shaped groove of the crossarm end fixture is clamped on the U-shaped hanger plate and the ball eye, and the middle internal cavity of the second fixture is clamped on the stress fitting surface of the insulator steel cap without interfering with the front and rear insulators. By means of the tightening assemblies, the first insulator on the straight line string crossarm side may be replaced.

Seventh, according to the method for replacing a single insulator of the disclosure, the types and installation positions of the first fixture and the second fixture are adaptively and flexibly selected according to different positions (crossarm side, conductor side or any intermediate position) of the insulator to be replaced in the tension string or straight line string, and combined with the combined use of the tightening assemblies and extension joints, so as to construct a retractable bearing structure suitable for different scenarios. The method realizes rapid positioning and replacement of a single insulator at any position in the insulator string, fundamentally solving the problem that a specific position insulator may not be replaced due to the single function of the fixture in conventional operation, and significantly improving the versatility and flexibility of the operation. Meanwhile, the method ensures stable bearing by the precise fitting between the closed fixture and the stress surface of the insulator steel cap, and completely unloads the mechanical load of the insulator to be replaced by gradually operating the tightening assemblies, thereby simplifying the high-altitude assembly and disassembly process on the premise of ensuring operation safety, significantly improving the operation efficiency and reliability of single insulator replacement, and effectively solving the problems of high labor intensity, high safety risk and complicated replacement process in conventional operation methods.

### BRIEF DESCRIPTION OF THE DRAWINGS

In order to explain the embodiments of the disclosure or the technical solutions in the prior art more clearly, a brief introduction will be given below to the accompanying drawings required in the embodiments. Obviously, the drawings described below are only some embodiments of the disclosure. For those ordinary skilled in the art, other drawings may be obtained based on these drawings without creative efforts.

FIG. 1 is a schematic structural view of a closed fixture device for replacing a single insulator according to Embodiment 1 of the disclosure;

FIG. 2 is a front structural schematic view of the closed fixture in the closed fixture device for replacing a single insulator according to Embodiment 1 of the disclosure;

FIG. 3 is a top structural schematic view of the closed fixture in the closed fixture device for replacing a single insulator according to Embodiment 1 of the disclosure;

FIG. 4 is a cross-sectional structural schematic view taken along line A-A in FIG. 2;

FIG. 5 is a schematic structural view of a closed fixture device for replacing a single insulator according to Embodiment 2 of the disclosure;

FIG. 6 is a schematic structural view of a balance connecting plate in the closed fixture device for replacing a single insulator according to Embodiment 3 of the disclosure;

FIG. 7 is a schematic structural view of a closed fixture device for replacing a single insulator according to Embodiment 3 of the disclosure;

FIG. 8 is a schematic structural view of a closed fixture device for replacing a single insulator according to Embodiment 4 of the disclosure;

FIG. 9 is a schematic structural view of a closed fixture device for replacing a single insulator according to Embodiment 5 of the disclosure; and

FIG. 10 is a schematic structural view of the closed fixture device for replacing a single insulator according to Embodiment 5 of the disclosure.

List of reference characters: 1 first fixture; 11 main clamp; 12 ear plate; 13 auxiliary clamp cover; 14 special articulated bolt; 15 nut; 10 and 21 crossarm end fixture; 22 connecting plate; 23 socket-clevis eye; 9 and 24 conductor end fixture; 3 tightening assembly; 4 extension joint; 5 insulator; 51 pulling plate; 6 balance connecting plate; 7 U-shaped hanger plate; and 8 ball eye.

### DETAILED DESCRIPTION OF THE EMBODIMENTS

The embodiments of the disclosure are described in detail below, examples of which are shown in the accompanying drawings, where identical or similar reference numerals represent identical or similar elements or elements having identical or similar functions throughout. The embodiments described below with reference to the accompanying drawings are exemplary, only for explaining the disclosure, and shall not be construed as limiting the disclosure.

In the description of the disclosure, it should be understood that the orientation or positional relationships indicated by the terms “length”, “width”, “inner”, “outer” and the like are based on the orientation or positional relationships shown in the accompanying drawings, which are only for the convenience of describing the disclosure and simplifying the description, rather than indicating or implying that the referred device or element have a specific orientation, be constructed and operated in a specific orientation, and therefore may not be construed as limiting the disclosure. In addition, the terms “first” and “second” are used for descriptive purposes only and may not be construed as indicating or implying relative importance or implicitly indicating the number of indicated technical features. Thus, features defined with “first” and “second” may explicitly or implicitly include one or more of such features. In the description of the disclosure, the term “plurality” means two or more, unless otherwise specifically and clearly defined.

In the description of the disclosure, it should be noted that, unless otherwise explicitly specified and defined, the terms “mounted”, “connected”, and “connection” should be understood in a broad sense. For example, the fixedly connecting may be, detachably connecting, or integrally connecting may also be; the directly connecting, or the indirectly connecting through an intermediate medium may be, and the internal communication between two elements or an interaction relationship between two elements may be. For those ordinary skilled in the art, the specific meanings of the above terms in the disclosure may be understood according to specific circumstances.

Embodiment 1

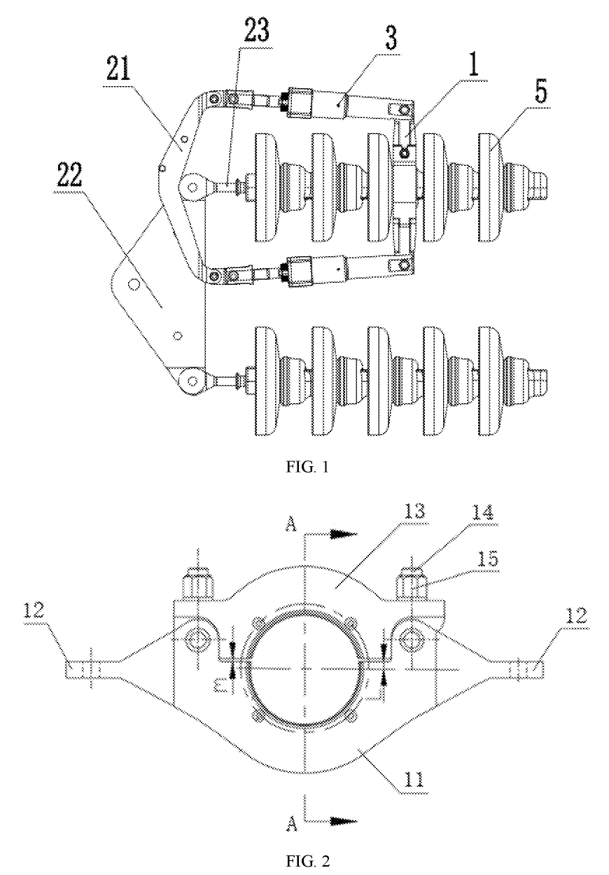

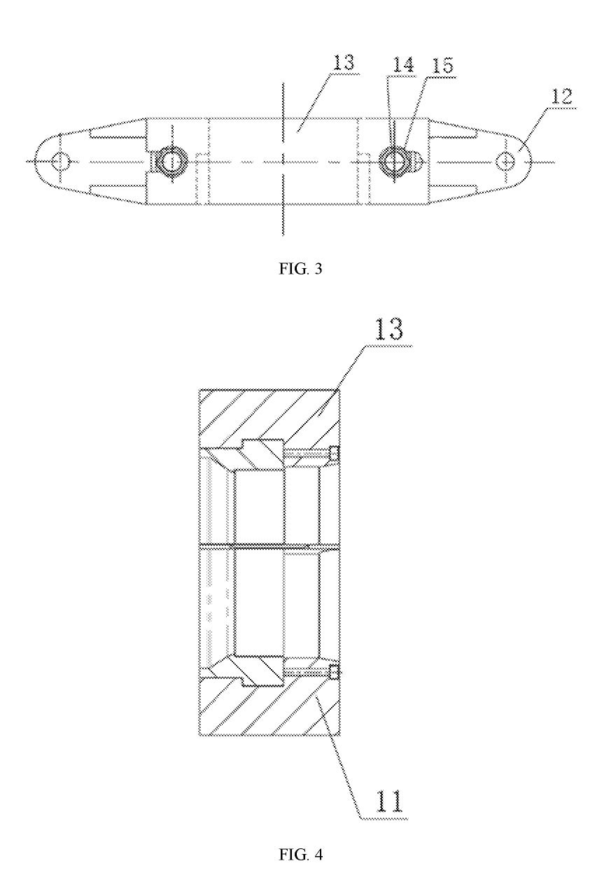

As shown in FIGS. 1 to 4, the closed fixture device for replacing a single insulator according to Embodiment 1 includes a first fixture, a second fixture, tightening assemblies 3 and extension joints 4, where the first fixture 1 and the second fixture are respectively clamped and positioned on an insulator string; a retractable bearing structure is formed by connecting two the extension joints 4 and the tightening assemblies 3 between the first fixture 1 and the second fixture; and the first fixture 1 and/or the second fixture include a main clamp and an auxiliary clamp cover and are connected by pin shafts, special-shaped articulated bolts 14 and nuts 15; a center of the main clamp 11 is a semi-circular arc body, with symmetrically arranged ear plates 12 on both sides; the ear plates 12 are provided with connecting holes for connecting the extension joints 4 or the tightening assemblies 3; the special-shaped articulated bolts 14 are symmetrically assembled on the main clamp 11; the main clamp 11 and the auxiliary clamp cover 13 are connected in combination through the special-shaped articulated bolts 14, the pin shafts and the nuts 15, and and a central hole is formed for accommodating an insulator steel cap after combination; and a stress surface of the central hole is matched with a fitting section of a steel cap boss.

In Embodiment 1, the second fixture is a crossarm end fixture 21 for a tension string, the crossarm end fixture 21 is clamped at a connecting position between a connecting plate 22 and a socket-clevis eye 23; a middle internal cavity of the first fixture 1 is clamped on a stress fitting surface of the insulator steel cap, so as to replace a first insulator on a tension string crossarm side. Where, the crossarm end fixture 21, the first fixture 1 and the tightening assemblies 3 form a retractable device.

Furthermore, the material of the inner surface of the central hole is metal or high-strength aluminum alloy.

Where, the first fixture 1 and/or the second fixture include the main clamp and the auxiliary clamp cover, and are connected by the pin shafts, the special-shaped articulated bolts 14 and the nuts 15, and an openable and closable semi-circular arc body is formed, and an internal cavity is completely fitted with a stress fitting surface of the insulator steel cap.

Preferably, each of the tightening assemblies 3 is a labor-saving gear tightening screw, a mechanical ratchet tightening screw or a manual hydraulic tensioner.

When the closed fixture device for replacing a single insulator of Embodiment 1 is in use, as shown in FIG. 1, first, the crossarm end fixture 21 of the tension string is clamped at the connecting position between the connecting plate 22 and the socket-clevis eye 23, the installation position of the first fixture 1 on the insulator string is determined, and the first fixture 1 is installed. The required length of the lead screw is measured according to the on-site distance, and the extension joint 4 is installed to adjust the installation position when the lead screw length is insufficient. Then, the extension joint 4 and the tightening assembly 3 are respectively connected to the first fixture 1 and the crossarm end fixture 21, and the nut 15 is fastened. The tightening assembly 3 is rotated by a ratchet wrench to bear force, and the load is gradually transferred to the first fixture 1 and the crossarm end fixture 21. The tightening assembly 3 is continuously operated to tighten gradually until the insulator 5 is loosened to a detachable state, and then the insulator on the tension string crossarm side may be safely replaced.

Embodiment 2

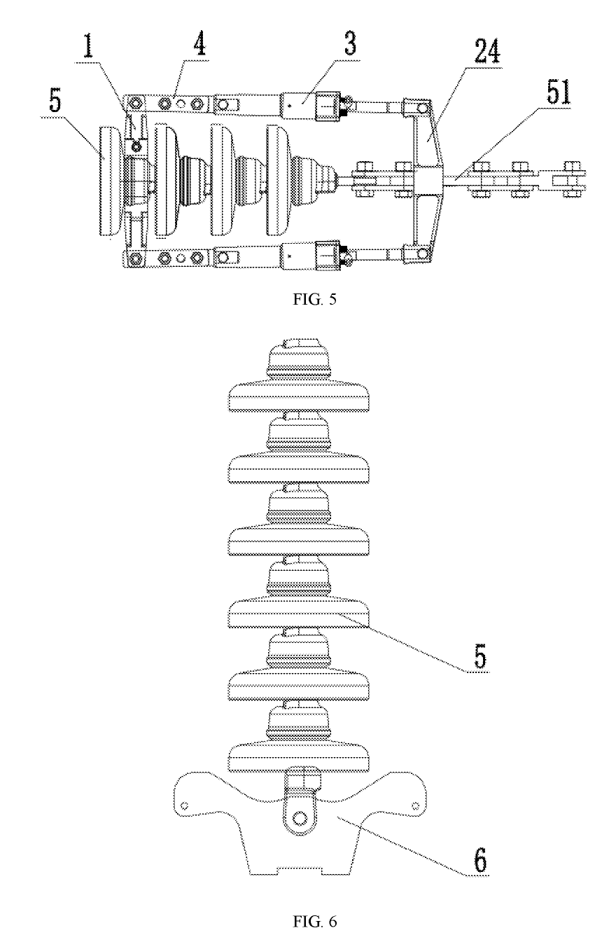

As shown in FIG. 5, the closed fixture device for replacing a single insulator according to Embodiment 2 differs from that according to Embodiment 1 in that the first fixture is a conductor end fixture 24 for a tension string, the conductor end fixture 24 is clamped on a pulling plate, one end of the insulator string is provided with the pulling plate 51, and the conductor end fixture 24 is clamped to the pulling plate 51; a middle internal cavity of the second fixture is clamped on a stress fitting surface of the insulator steel cap, so as to replace a first insulator on a tension string conductor side.

Where, the conductor end fixture 24, the second fixture and the tightening assemblies 3 form a retractable device.

When the closed fixture device for replacing a single insulator of Embodiment 2 is in use, as shown in FIG. 5, first, the conductor end clamp 24 of the tension string is clamped onto the pulling plate 51, the installation position of the second fixture on the insulator string is determined, and the second fixture is installed. The required length of the lead screw is measured according to the on-site distance, and the extension joint 4 is installed to adjust the installation position when the lead screw length is insufficient. Then, the extension joint 4 and the tightening assembly 3 are respectively connected to the second fixture and the conductor end clamp 24, and the nut 15 is fastened. The tightening assembly 3 is rotated by a ratchet wrench to bear force, and the load is gradually transferred to the second fixture and the conductor end fixture 24. The tightening assembly 3 is continuously operated to tighten gradually until the insulator 5 is loosened to a detachable state, and then the insulator on the tension string conductor side may be safely replaced.

Embodiment 3

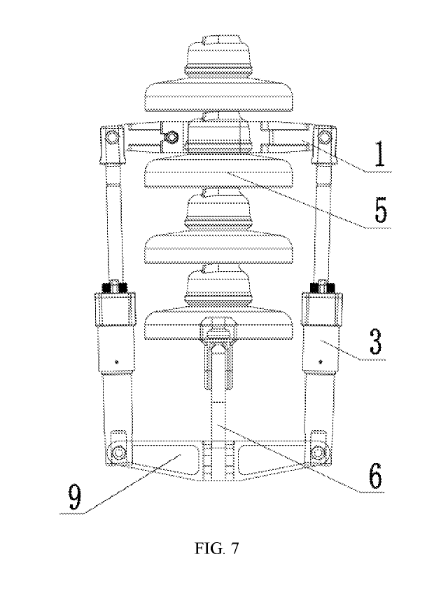

As shown in FIGS. 6 and 7, the closed fixture device for replacing a single insulator according to Embodiment 3 differs from that according to Embodiment 1 in that the second clamp is a conductor end clamp 9 for a straight line string, a middle shaped groove of the conductor end fixture 9 is clamped on a balance connecting plate 6, a middle internal cavity of the first fixture 1 is clamped on a stress fitting surface of the insulator steel cap, so as to replace a first insulator on a straight line string conductor side, and the conductor end fixture 9, the first fixture 1 and the tightening assemblies 3 form a retractable device.

The use process of the closed fixture device for replacing a single insulator according to Embodiment 3 is similar to that of Embodiment 1, and will not be repeated here.

Embodiment 4

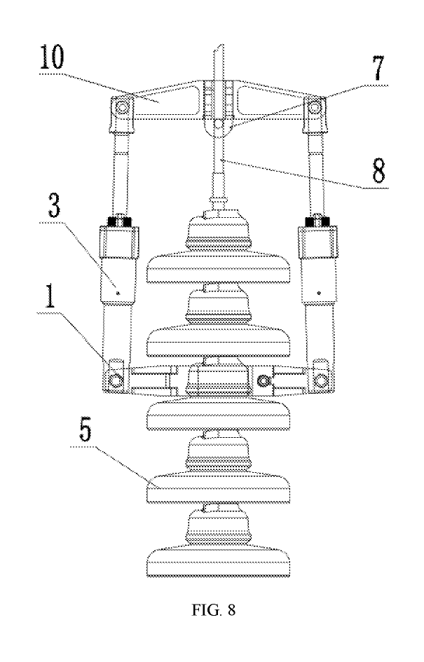

As shown in FIG. 8, the closed fixture device for replacing a single insulator according to Embodiment 4 differs from that according to Embodiment 1 in that the first fixture is a crossarm end fixture 10 for a straight line string, one end of the insulator string is provided with a U-shaped hanger plate 7 and a ball eye 8, a middle shaped groove of the crossarm end fixture 10 is clamped on the U-shaped hanger plate 7 and the ball eye 8, a middle internal cavity of the second fixture is clamped on a stress fitting surface of the insulator steel cap, so as to replace a first insulator on a straight line string crossarm side, and the crossarm end fixture 10, the second fixture and the tightening assemblies 3 form a retractable device.

The use process of the closed fixture device for replacing a single insulator according to Embodiment 4 is similar to that of Embodiment 2, and will not be repeated here.

Embodiment 5

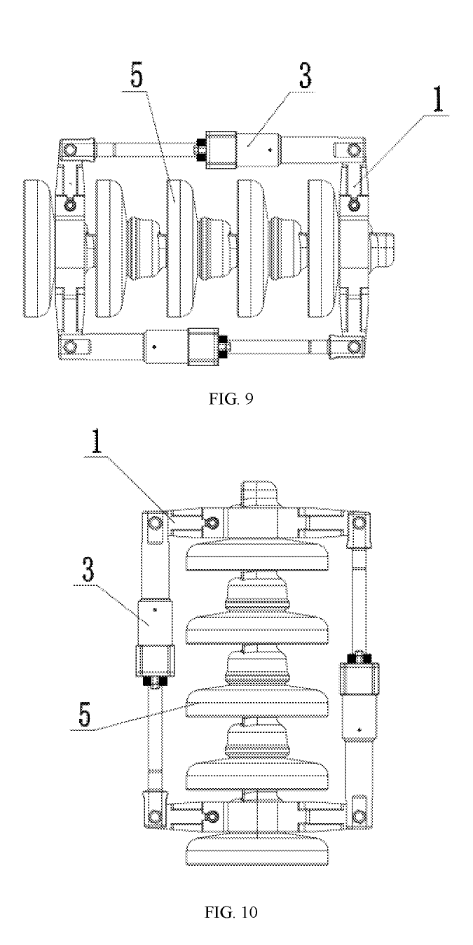

As shown in FIGS. 9 and 10, the closed clamp device for replacing a single insulator according to Embodiment 5 differs from that according to Embodiment 1 in that the first fixture 1 and the second fixture have the same structure, and both the first fixture 1 and the second fixture are matched, clamped and positioned with the stress surface of the steel cap of the insulator 5.

When the closed fixture device for replacing a single insulator according to Embodiment 5 is in use, firstly, the first fixture 1 and the second fixture are respectively installed and fastened on the steel caps of the insulator to be replaced in the tension string or the straight line string. Then, the extension joint 4 and the tightening assembly 3 are respectively connected to the first fixture 1 and the second fixture, and the nut 15 is fastened. The tightening assembly 3 is rotated by a ratchet wrench to bear force, and the load is gradually transferred to the first fixture 1 and the second fixture. The tightening assembly 3 is continuously operated to tighten gradually until the insulator 5 is loosened to a detachable state, so that the defective insulator in the tension string or the straight line string may be safely replaced.

Embodiment 6

The method for replacing a single insulator according to Embodiment 6 adopts the closed fixture device for replacing a single insulator, and includes the following steps.

S1: a position of an insulator to be replaced in the insulator string is determined;

S2: installation positions and types of the first fixture and the second fixture are selected according to the position of the insulator to be replaced:

if replacing a first insulator on a tension string crossarm side, the second fixture is used as a crossarm end fixture of a tension string and is clamped at a connecting position between a connecting plate and a socket-clevis eye, an installation position of the first fixture on the insulator string is determined and the first fixture is installed;

if replacing a first insulator on a tension string conductor side, the first fixture is used as a conductor end fixture of a tension string and is clamped on a pulling plate, an installation position of the second fixture on the insulator string is determined and the second fixture is installed;

if replacing a first insulator on a straight line string conductor side, the second fixture is used as a conductor end fixture of a straight line string and is clamped on a balance connecting plate, and a middle internal cavity of the first fixture is clamped on a stress fitting surface of the insulator steel cap;

if replacing a first insulator on a straight line string crossarm side, the first fixture is used as a crossarm end fixture of a straight line string and is clamped on a U-shaped hanger plate and a ball eye, and a middle internal cavity of the second fixture is clamped on a stress fitting surface of the insulator steel cap;

if replacing an insulator at any position in the insulator string, the first fixture and the second fixture are respectively clamped on the insulator steel cap, and are installed and fastened;

S3: whether to use the extension joints is selected and installation lengths of the tightening assemblies are adjusted according to a distance between the first fixture and the second fixture;

S4: both ends of each of the tightening assemblies are connected and fastened with the first fixture and the second fixture respectively;

S5: the tightening assemblies are operated to gradually bear force until the insulator to be replaced is loosened; and

S6: the insulator to be replaced is disassembled and a new insulator is installed.

Preferably, each of the tightening assemblies 3 is a labor-saving gear tightening screw, a mechanical ratchet tightening screw or a manual hydraulic tensioner, and in S5, a corresponding tool is used to operate the tightening assemblies to gradually tighten.

Where, during installation of the first fixture 1 and/or the second fixture, the main clamp and the auxiliary clamp cover 13 are combined through the special-shaped articulated bolts 14, the pin shafts and the nuts 15 to form the central hole fitted with a stress surface of the insulator steel cap.

In S5, each of the tightening assemblies is operated until mechanical load of the insulator to be replaced in the insulator string is completely unloaded.

The method for replacing a single insulator according to Embodiment 6 adaptively and flexibly selects the types and installation manners of the first fixture 1 and the second clamp according to the different positions of the insulator to be replaced in the tension string or the straight line string (crossarm side, conductor side or any intermediate position), and realizes rapid and safe replacement of the insulator at any position in the insulator string by cooperating with the combined use of the tightening assembly 3 and the extension joint 4. Meanwhile, the method ensures stable bearing by means of precise fitting between the closed fixture and the stress surface of the insulator steel cap, and completely unloads the mechanical load of the insulator to be replaced through gradual tightening, thereby simplifying the operation process, significantly improving the operation efficiency and safety, and effectively solving the problem of difficult replacement caused by single function and complex assembly and disassembly of the clamp in the traditional operation mode.

The disclosure realizes rapid and safe replacement of insulators at the crossarm side, conductor side and any intermediate position of the tension string or straight line string insulator string through a modular structural design, and significantly improves the versatility and operation flexibility of the tool. The first fixture and/or the second fixture adopt a openable and closable structure of a main clamp and an auxiliary clamp cover, which are connected by a pin shaft and a special articulated bolt, and the inner cavity thereof is precisely fitted with the stress surface of the steel cap, so as to firmly clamp the insulator at any intermediate position. For the end positions, the crossarm end fixture or conductor end fixture may form a retractable device with the closed fixture and the tightening assembly, so as to efficiently complete the replacement of the end insulator without interference, effectively solving the problems that the traditional operation requires the replacement of the whole string or the fixture has a single function.

The embodiments described above are only descriptions of the preferred modes of the disclosure, and are not intended to limit the scope of the disclosure. Without departing from the design spirit of the disclosure, various modifications and improvements made to the technical solutions of the disclosure by those ordinary skilled in the art shall fall within the protection scope defined by the claims of the disclosure.

What is claimed is:

1. A closed fixture device for replacing a single insulator, comprising a first fixture, a second fixture, tightening assemblies and extension joints, wherein the first fixture and the second fixture are respectively clamped and positioned on an insulator string; a retractable bearing structure is formed by connecting two the extension joints and the tightening assemblies between the first fixture and the second fixture; and the first fixture and/or the second fixture comprise a main clamp and an auxiliary clamp cover and are connected by pin shafts, special-shaped articulated bolts and nuts; a center of the main clamp is a semi-circular arc body, with symmetrically arranged ear plates on both sides; the ear plates are provided with connecting holes for connecting the extension joints or the tightening assemblies; the special-shaped articulated bolts are symmetrically assembled on the main clamp; the main clamp and the auxiliary clamp cover are connected in combination through the special-shaped articulated bolts, the pin shafts and the nuts, and and a central hole is formed for accommodating an insulator steel cap after combination; and a stress surface of the central hole is matched with a fitting section of a steel cap boss.

2. The closed fixture device for replacing a single insulator according to claim 1, wherein the second fixture is a crossarm end fixture for a tension string, the crossarm end fixture is clamped at a connecting position between a connecting plate and a socket-clevis eye; a middle internal cavity of the first fixture is clamped on a stress fitting surface of the insulator steel cap, so as to replace a first insulator on a tension string crossarm side; the crossarm end fixture, the first fixture and the tightening assemblies form a retractable device.

3. The closed fixture device for replacing a single insulator according to claim 1, wherein the first fixture is a conductor end fixture for a tension string, the conductor end fixture is clamped on a pulling plate, one end of the insulator string is provided with the pulling plate, and the conductor end fixture is clamped to the pulling plate; a middle internal cavity of the second fixture is clamped on a stress fitting surface of the insulator steel cap, so as to replace a first insulator on a tension string conductor side; the conductor end fixture, the second fixture and the tightening assemblies form a retractable device.

4. The closed fixture device for replacing a single insulator according to claim 1, wherein the second fixture is a conductor end fixture for a straight line string, a middle shaped groove of the conductor end fixture is clamped on a balance connecting plate, a middle internal cavity of the first fixture is clamped on a stress fitting surface of the insulator steel cap, so as to replace a first insulator on a straight line string conductor side, and the conductor end fixture, the first fixture and the tightening assemblies form a retractable device.

5. The closed fixture device for replacing a single insulator according to claim 1, wherein the first fixture is a crossarm end fixture for a straight line string, one end of the insulator string is provided with a U-shaped hanger plate and a ball eye, a middle shaped groove of the crossarm end fixture is clamped on the U-shaped hanger plate and the ball eye, a middle internal cavity of the second fixture is clamped on a stress fitting surface of the insulator steel cap, so as to replace a first insulator on a straight line string crossarm side, and the crossarm end fixture, the second fixture and the tightening assemblies form a retractable device.

6. The closed fixture device for replacing a single insulator according to claim 1, wherein the first fixture and the second fixture have a same structure, and both the first fixture and the second fixture are fittingly clamped and positioned in cooperation with a stress surface of the insulator steel cap, and the first fixture, the second fixture and the tightening assemblies form a retractable device.

7. The closed fixture device for replacing a single insulator according to claim 1, wherein the first fixture and/or the second fixture comprise the main clamp and the auxiliary clamp cover, and are connected by the pin shafts, the special-shaped articulated bolts and the nuts, and an openable and closable semi-circular arc body is formed, and an internal cavity is completely fitted with a stress fitting surface of the insulator steel cap.

8. The closed fixture device for replacing a single insulator according to claim 1, wherein each of the tightening assemblies is a labor-saving gear tightening screw, a mechanical ratchet tightening screw or a manual hydraulic tensioner.

9. A method for replacing a single insulator, adopting the closed fixture device for replacing a single insulator according to claim 1, comprising:
S1: determining a position of an insulator to be replaced in the insulator string;
S2: selecting installation positions and types of the first fixture and the second fixture according to the position of the insulator to be replaced:
if replacing a first insulator on a tension string crossarm side, using the second fixture as a crossarm end fixture of a tension string and clamping at a connecting position between a connecting plate and a socket-clevis eye, determining an installation position of the first fixture on the insulator string and installing the first fixture;
if replacing a first insulator on a tension string conductor side, using the first fixture as a conductor end fixture of a tension string and clamping on a pulling plate, determining an installation position of the second fixture on the insulator string and installing the second fixture;
if replacing a first insulator on a straight line string conductor side, using the second fixture as a conductor end fixture of a straight line string and clamping on a balance connecting plate, and clamping a middle internal cavity of the first fixture on a stress fitting surface of the insulator steel cap;
if replacing a first insulator on a straight line string crossarm side, using the first fixture as a crossarm end fixture of a straight line string and clamping on a U-shaped hanger plate and a ball eye, and clamping a middle internal cavity of the second fixture on a stress fitting surface of the insulator steel cap;
if replacing an insulator at any position in the insulator string, respectively clamping the first fixture and the second fixture on the insulator steel cap, and installing and fastening;
S3: selecting whether to use the extension joints and adjusting installation lengths of the tightening assemblies according to a distance between the first fixture and the second fixture;
S4: connecting and fastening both ends of each of the tightening assemblies with the first fixture and the second fixture respectively;
S5: operating the tightening assemblies to gradually bear force until the insulator to be replaced is loosened; and
S6: disassembling the insulator to be replaced and installing a new insulator.

10. The method for replacing a single insulator according to claim 9, wherein each of the tightening assemblies is a labor-saving gear tightening screw, a mechanical ratchet tightening screw or a manual hydraulic tensioner, and in S5, a corresponding tool is used to operate the tightening assemblies to gradually tighten.

11. The method for replacing a single insulator according to claim 9, wherein during installation of the first fixture and/or the second fixture, the main clamp and the auxiliary clamp cover are combined through the special-shaped articulated bolts, the pin shafts and the nuts to form the central hole fitted with a stress surface of the insulator steel cap.

12. The method for replacing a single insulator according to claim 9, wherein in S5, each of the tightening assemblies is operated until mechanical load of the insulator to be replaced in the insulator string is completely unloaded.
